(19) United States
(12) Patent Application Publication
(10) Pub. No.: US 2016/0280878 A1
(43) Pub. Date: Sep. 29, 2016

(54) COMPOSITE COMPRISING A PLASTICIZED POLYURETHANE FOAM AND A COATING CONSISTING OF A PLASTICIZED PVC RESIN

(71) Applicant: RESINOPLAST, Reims (FR)

(72) Inventor: Nicolas Marie Emmanuel AMOUROUX, Reims (FR)

(21) Appl. No.: 15/034,147

(22) PCT Filed: Nov. 4, 2014
(86) PCT No.: PCT/EP2014/073704

§ 371 Date: May 3, 2016

(30) Foreign Application Priority Data
Nov. 4, 2013 (FR) 1360795

(51) Int. Cl. C08J 9/36; C08J 9/00; C09D 5/03; C08G 18/66; C08G 18/76; C09D 127/06; C08G 18/08; C08K 5/12

(52) U.S. Cl. CPC C08J 9/365; C08G 18/14; C08J 9/0023; C08K 5/12; C08G 18/6607; C08G 18/7664; C09D 127/06; C09D 5/033; C08J 2327/06; C08J 2475/04; C08G 2101/0083

(57) ABSTRACT

The invention relates to a composite comprising a plasticised polyurethane foam and a coating consisting of a plasticised PVC resin, to the method for the production thereof, and to the use of same for producing a panel for the parts of a car interior. The invention also relates to the use of a plasticising compound in a foam in contact with a coating consisting of a PVC resin, which also comprises a plasticising compound, for limiting or preventing the migration of the plasticising compound from the coating into the foam.

The invention relates to a composite comprising a plasticized polyurethane foam and a plasticized PVC resin coating, its preparation method and its use for the preparation of a panel of a compartment portion such as a dashboard with an airbag either integrated or not integrated, an airbag hatch, a glove box, a central console, a trim or a door panel.

The invention also relates to the use of a plasticizing compound within a foam in contact with a PVC resin coating also comprising a plasticizing compound for limiting or preventing the migration of the plasticizing compound of the coating into the foam.

The panels for automobile compartment portions are known from the state of the art. They generally consists of a composite comprising a rigid support, a flexible densified foam, either semi-rigid or rigid, notably a polyurethane foam, and a flexible grained and colored coating, resistant to thermal ageing, to ultraviolet rays (UVs) and to wear.

Various types of polyurethane foam have been described in the state of the art.

From EP 0 646 154, a hydro-inflated flexible polyurethane foam obtained from the plasticized composition comprising a compound of the polyurethane type is known, a non-halogenated blowing agent and plasticizer such as a phthalate, phosphate ester or benzoate plasticizer. The addition of a plasticizer gives the possibility of improving the flexibility, the suppleness of the hydro-inflated polyurethane foam.

From EP 1 361 239, is known a method for preparing a semi-rigid polyurethane foam. This foam may be an element for a composite with thermoplastic polymers such as polyvinyl chloride.

From U.S. Pat. No. 4,526,908, is known a polyurethane-polyisocyanurate cell foam obtained by reaction of an isocyanate and a liquid and homogenous resin. This liquid resin comprises a composition comprising a mixture of esters obtained from phthalic acid or anhydride and from trimellitic acid or anhydride and from aliphatic polyols. The use of this liquid resin for preparing an economical cell foam and of commercial quality.

A plasticized PVC resin coating also called a skin layer or composite structure is described in WO 2007/101968. The composition described in WO 2007/101968 comprises a matrix based on thermoplastic resins such as PVC for producing single layer skins or composites with a mottled aspect for compartment portions of a vehicle. This matrix may comprise at least one plasticizer such as azelates, trimellitates, sebacates, adipates, polyadipates, phthalates, polyphthalate, citrates, benzoates, tallates, glutarates, fumarates, maleates, oleates, palmitates and acetates. The thereby obtained skin layer or composite structure has cold resistance, hardness and thermal ageing resistance properties according to the requirements sheet required for automotive application.

From FR 2 750 700, a foam with an integrated skin and made from a foam comprising a thermoplastic resin such as polyvinyl chloride, the chlorinated polyvinyl chloride, the copolymers of vinyl and of vinyl acetate and of a skin also comprising a thermoplastic resin such as polyvinyl chloride, is known.

A method for preparing a product in molded semi-rigid polyurethane is also described in EP 0 881 245. This product comprises a reaction mixture for forming optionally plasticized polyurethane and a sheet or film of plastic material. However, the method according to EP 0 881 245 proposes avoidance of the formation of holes or empty spaces between the foam and the coating by means of the use of this reaction mixture for preparing a product in semi-rigid polyurethane.

However, the molded semi-rigid polyurethane product according to EP 0 881 245 does not give the possibility of obtaining a composite which, during its ageing, retains the flexibility properties of the coating of a recently produced composite.

It is known that during ageing of a composite comprising a densified, flexible, semi-rigid or rigid foam, notably a polyurethane foam, and a coating, notably in plasticized PVC resin(s), it is observed that the plasticizing compound initially present in the coating migrates into the foam. This migration causes shrinkage of the coating, loss of flexibility of the coating, and increases the fragility of this coating. In the case of a dashboard integrating an invisible airbag, the shrinkage of the coating is expressed by increased visibility overtime of the precut line of the airbag hatch.

The thereby embrittled coating, notably the coating masking the airbag hatch, may be fractured during an airbag fault, causing projection of coating particles which may injure the occupants of the automobile compartment.

Surprisingly, it was shown that the use of a plasticizing compound within a polyurethane foam in contact with a PVC resin coating comprising a plasticizing compound limits in time the migration of the plasticizing compound comprised in the coating, towards the polyurethane foam. Thus, the aged composite retains its flexibility properties overtime.

Surprisingly, it was shown that the variations in the mechanical properties of the aged coatings and in contact with a foam comprising a plasticizing compound are much less than the variations in the mechanical properties of the aged coating and in contact with a foam without any plasticizing compound.

In a quite also surprising way, the applicant developed a composite comprising a plasticized polyurethane foam and a plasticized PVC resin coating with retains its flexibility properties overtime.

Just as surprisingly, the invention relates to a composite comprising a plastisized polyurethane foam and a plasticized PVC resin coating, for which the plasticizing compound content gives the possibility of limiting or preventing migration of the plasticizer comprised in the coating, towards the polyurethane foam.

The invention therefore provides a solution to all or part of the problems related to the means of the state of the art for developing a composite used for preparing a panel for automobile compartment portions.

The invention relates to a composite comprising:
a foam of at least one polyurethane compound comprising at least one plasticizing compound (P1) selected from compounds and their derivatives stemming from the condensation between at least one acid comprising a linear, branched or cyclic, saturated or unsaturated, C₄-C₂₁ alkyl chain, and comprising at least one acid function selected from a carboxylic acid function, a sulfonic acid function or a phosphoric acid function, and at least one compound comprising at least one hydroxyl function;
a coating comprising at least one PVC resin and at least one plasticizing compound (P2) selected from compounds and their derivatives stemming from the condensation between at least one acid comprising a linear, branched or cyclic, saturated or unsaturated, C₄-C₂₁ alkyl chain and comprising at least one acid function selected from a carboxylic acid function, a sulfonic acid function or a phosphoric acid function, and at least one compound comprising at least one hydroxyl function.

Preferably, the composite comprises during its making, from 3 to 30% by weight of a plasticizing compound (P1) in the foam based on the total weight of foam. Preferably, the thereby described composite may be defined as a non-aged composite. By [symbol] non-aged [symbol] is meant a composite not having yet been subject to alteration overtime, of its mechanical properties as well as its flexibility properties. This alteration of its properties is generally due to outer chemical and mechanical aggressions, such as temperature differences, impacts, exposure to ultraviolet rays etc. Thus by [symbol] non-aged composite [symbol] is meant the composite directly obtained by the method of the invention also called an initial composite.

Preferably, the composite according to the invention is non-aged.

Advantageously, the acid function may be in the form of an acid function, a corresponding anhydride function or a corresponding acid chloride function.

In particular, the carboxylic acid function may be in the form of a carboxylic acid function, of a carboxylic acid anhydride function or of an acyl chloride function. In particular, the sulfonic acid function may be in the form of a sulfonyl chloride function. In particular, the phosphoric acid function may be in the form of a phosphoryl chloride function.

Advantageously, the composite according to the invention has a thickness comprised between 2.5 and 22.5 mm.

According to the invention, the compound comprising at least one hydroxyl function is selected from methanol, ethanol, n-butanol, iso-butanol, n-hexanol, benzanol, n-heptanol, 2-ethylhexanol, n-octanol, iso-octanol, iso-nonol, n-nonanol, n-decanol, iso-decanol, undecanol, dodecanol, tridecanol, glycerol, diglycerol, neopentylglycol, trimethylolpropane, monopentaerythritol, dipentaerythritol, ethylene glycol, propylene glycol, tri-methylene glycol, tetra-methylene glycol, cresol, or phenol.

Preferably, the compound comprising at least one hydroxyl function is selected from 2-ethylhexanol, n-octanol, n-decanol, iso-decanol, undecanol, dodecanol or tridecanol.

According to the invention, the plasticizing compound (P1) or (P2) may be independently selected from the compounds and their derivatives stemming from the condensation between:
at least one acid comprising a linear, branched or cyclic, saturated or unsaturated, C₄-C₂₁ alkyl chain and comprising at least two carboxylic acid functions, and at least one compound comprising a hydroxyl function;
at least one acid comprising a linear, branched or cyclic, saturated or unsaturated, C₄-C₂₁ alkyl chain and comprising a carboxylic acid function, and a compound comprising at least two hydroxyl functions;
at least one acid comprising a linear, branched or cyclic, saturated or unsaturated, C₄-C₂₁ alkyl chain and comprising two carboxylic acid functions, and at least one compound comprising two hydroxyl functions;
at least one acid comprising a linear, branched or cyclic, saturated or unsaturated, C₄-C₂₁ alkyl chain and comprising at least one sulfonic acid function, and at least one compound comprising a hydroxyl function;
at least one acid comprising a linear, branched or cyclic, saturated or unsaturated, C₄-C₂₁ alkyl chain and comprising at least one phosphoric acid function, and at least one compound comprising a hydroxyl function; or
mixtures thereof.

Preferably, the acid comprising a linear, branched or cyclic C₄-C₂₁ alkyl chain and comprising at least two carboxylic acid functions, may be selected from among phthalic acid, maleic acid, succinic acid, sebacic acid, adipic acid, glutaric acid or trimellitic acid, more preferentially phthalic acid, sebacic acid, adipic acid or trimellitic acid.

It is understood in the sense of the invention that trimellitic acid may be in the form of trimellitic anhydride.

In the sense of the invention it is understood that phthalic acid may be in the form of phthalic anhydride.

According to the invention, the plasticizing compound (P1) or (P2) may be independently selected from among the esters obtained from a plant oil.

Preferably, the plasticizing compound (P1) or (P2) may be independently selected from trimellitate compounds; sebacate compounds; adipate compounds; polyadipate compounds; phthalate compounds; polyphthalate compounds; terephthalate compounds; citrate compounds; polyglutarate compounds; maleate compounds; polyethyleneglycol polyether compounds; acetylated monoglyceride compounds; compounds stemming from the condensation between at least one acid comprising a linear or branched C₄-C₂₁ alkyl chain and comprising one carboxylic acid function, and at least one compound selected from glycerol, diglycerol, neopentylglycol, trimethylolpropane, monopentaerythritol or dipentaerythritol; di-iso-nony1,2-cyclohexane dicarboxylate; sulfonate compounds; phosphate compounds; or mixtures thereof.

Advantageously, the plasticizing compound (P1) or (P2) may be independently selected from among trimellitate compounds, sebacate compounds, adipate compounds, or mixtures thereof, more advantageously from among trimellitate compounds.

Also advantageously, the plasticizing compounds (P1) and (P2) are selected from a single family of compounds, notably from the family of trimellitate compounds, sebacate compounds, adipate compounds, or mixtures thereof, more advantageously from the family of trimellitate compounds. This advantageously gives the possibility of significantly limiting the migration of the plasticizer comprised in the coating towards the foam.

Advantageously, the plasticizing compound (P1) or the plasticizing compound (P2) is independently selected from among tris-(2-ethylhexyl)trimellitate, tris-(n-octyl)trimellitate, tris-(n-octyl, n-decanyl)trimellitate, diisodecyl sebacate, ditridecyladipate, or mixtures thereof.

According to the invention, the trimellitate compounds are selected from among the compounds stemming from the condensation between trimellitic acid and at least one compound comprising a hydroxyl function selected from a linear or branched alcohol comprising from 2 to 18 carbon atoms, preferably comprising from 2 to 13 carbon atoms, more preferentially selected from n-heptanol, 2-ethylhexanol, n-octanol, n-nonanol, n-decanol or mixtures thereof. Examples of trimellitate compounds are Polynt DIPLAST®TM8, Polynt DIPLAST®TM/ST, Polynt DIPLAST®TM8-10/ST, marketed by Polynt.

More particularly, an example of a commercial product of tris-(octyl)trimellitate is Diplast®TM8 (CAS: 89-04-3) marketed by Polynt.

More particularly, an example of a commercial product of tris-(n-octyl, n-decanyl)trimellitate is Diplast®TM8-10/ST marketed by Polynt.

According to the invention, the phthalate compounds or polyphthalate compounds are selected from among the compounds stemming from the condensation between phthalic anhydride and at least one compound comprising a hydroxyl function selected from among a linear or branched alcohol comprising from 2 to 18 carbon atoms, preferably comprising from 2 to 13 carbon atoms, more preferentially selected from among 2-ethylhexanol, n-octanol, iso-octanol, nonanol, isodecanol, n-decanol, undecanol, dodecanol, tridecanol or mixtures thereof. An example of a phthalate compound is DIPLAST®L11/ST marketed by Polynt.

According to the invention, the sebacate compounds are selected from compounds stemming from the condensation between sebacic acid and at least one compound comprising a hydroxyl function selected from among a linear or branched alcohol comprising from 2 to 18 carbon atoms, preferably comprising from 2 to 13 carbon atoms, more preferentially isodecanol. An example of a sebacate compound is CEREPLAS®DIDS marketed by INEOS Enterprises.

According to the invention, the adipate compounds or the polyadipate compounds are selected from the compounds stemming from the condensation between adipic acid and at least one compound comprising a hydroxyl function selected from among a linear or branched alcohol comprising from 2 to 18 carbon atoms, preferably comprising from 2 to 13 carbon atoms, more preferentially tridecanol. An example of an adipate compound is CEREPLAS®DTDA marketed by Polynt. An example of a polyadipate compound is Polynt Polymix®150N marketed by Polynt.

According to the invention, the maleate compounds are selected from compounds stemming from the condensation between maleic acid and at least one compound comprising a hydroxyl function selected from among a linear or branched alcohol comprising from 2 to 18 carbon atoms.

According to the invention, the terephthalate compounds are selected from the compounds stemming from the condensation between terephthalic acid and at least one compound comprising a hydroxyl function selected from among a linear or branched alcohol comprising from 2 to 18 carbon atoms, preferably comprising from 2 to 13 carbon atoms, more preferentially 2-ethylhexanol. An example of a terephthalate compound is DEHT-Eastman®168 marketed by Eastman Chemical Company.

According to the invention, the citrate compounds are selected from the compounds stemming from the condensation between citric acid or esterified citric acid and at least one compound comprising a hydroxyl function selected from among a linear or branched alcohol comprising from 2 to 18 carbon atoms, preferably comprising from 2 to 13 carbon atoms, more preferentially n-butanol, n-hexanol, or mixtures thereof.

According to the invention, the esterified citric acid is citric acid, the hydroxyl function of which is condensed with an acid selected from acetic acid or butyric acid.

An example of a citrate compound is acetyl tri-n-butyl citrate®ATBC marketed by KLJ Group.

According to the invention, the polyglutarate compounds are selected from the compounds stemming from the condensation between glutaric acid and at least one compound comprising two hydroxyl functions selected from among a linear or branched dialcohol comprising from 2 to 18 carbon atoms, preferably comprising from 2 to 13 carbon atoms, more preferentially ethylene glycol, propylene glycol, tri-methylene glycol or tetra-methylene glycol.

According to the invention, the polyethyleneglycol polyether compounds are selected from triethyleneglycol dihexanoate, tetraethyleneglycol diheptanoate, or mixtures thereof.

According to the invention, the acetylated monoglyceride compounds are selected from among acetylated glycerol monostearate, acetylated glycerol mono-12-acetylstearate, or mixtures thereof. An example of an acetylated monoglyceride compound is GRINSTED®SOFT-N-SAFE marketed by Danisco.

According to the invention, the compounds stemming from the condensation between at least one acid comprising a linear or branched C₄-C₂₁ alkyl chain and comprising at least one carboxylic acid function, and a compound comprising at least one hydroxyl function are compounds for which the compound comprising at least one hydroxyl function is selected from among neopentylglycol, trimethylolpropane, monopentaerythritol or dipentaerythritol. Examples of these compounds are marketed by Nyco. An example of these citrate compounds obtained by condensation of valeric acid and of dipentaerythritol is Nycobase®5600 marketed by Nyco.

The compound di-iso-nonyl 1,2-cyclohexane dicarboxylate is DINCH® marketed by BASF.

According to the invention, the sulfonate compounds are selected from the compounds stemming from the condensation between an acid comprising a linear, branched or cyclic, saturated or unsaturated, C₄-C₂₁ alkyl chain and comprising at least one sulfonic acid function, and at least one compound selected from among phenol, cresol or mixtures thereof. An example of a commercial product of phenyl cresyl sulfonate is Mesamoll® (CAS: 91082-17-6) marketed by Bayer.

According to the invention, the phosphate compounds are selected from the compounds stemming from the condensation between an acid comprising a linear, branched or cyclic, saturated or unsaturated, C₄-C₂₁ alkyl chain and comprising at least one phosphoric acid function, and at least one compound selected from among iso-decanol, cresol, 2-ethylhexanol, or mixtures thereof. Examples of phosphate compounds are iso-decylphosphate, tri-cresylphosphate or tri-(2-ethylhexyl)phosphate.

According to the invention, the plasticizing compound (P1) and the plasticizing compound (P2) are identical or are different.

Preferably, the plasticizing compound (P1) and the plasticizing compound (P2) are identical. By <<identical>> is meant that the plasticizing compounds (P1) and (P2) have a common chemical structure, i.e. the plasticizing compounds (P1) and (P2) both stem from a single and same family of plasticizing compounds.

Advantageously, the plasticizing compound (P1) and the plasticizing compound (P2) are tris-(n-octyl)trimellitate, tris-(2-ethylhexyl)trimellitate, tris-(n-octyl, n-decanyl)trimellitate, diisodecyl sebacate or mixtures thereof. Also preferably, the plasticizing compound (P1) and the plasticizing compound (P2) are different. Advantageously, the plasticizing compound (P1) or the plasticizing compound (P2) is independently tris-(n-octyl)trimellitate, tris-(2-ethylhexyl)trimellitate, tris-(n-octyl, n-decanyl)trimellitate, diisodecyl sebacate, ditridecyl adipate or mixtures thereof.

According to the invention, the foam comprises from 1 to 50% by weight of a plasticizing compound (P1) based on the total weight of foam, preferably from 3 to 30%, more preferentially from 10 to 30% by weight of a plasticizing compound (P1) based on the total weight of foam. Preferably, this percentage of plasticizing compound (P1) in the foam corresponds to the percentage during the making of the composite.

According to the invention, the foam may be expansed in a closed mold or may be freely expansed under 1 atmosphere. Preferably, the expansed foam in a closed mold has a density ranging from 50 to 300 g/liter, preferably ranging from 100 to 250 g/liter. Also preferably, the freely expansed foam according to the invention under 1 atmosphere has a density comprised between 20 and 100 g/liter, preferably ranging from 40 to 80 g/liter. The density of the foam is measured at 23° C.

Advantageously, the polyurethane foam has a thickness comprised between 2 and 20 mm, preferably between 5 and 10 mm.

According to the invention, the polyurethane foam is obtained by expansion of the composition (C1). The composition (C1) comprises at least one isocyanate compound, at least one polyol compound, at least one blowing agent and at least one plasticizer (P1) according to the invention. Preferably, the isocyanate compound may be in the form of a monomer, of dimers or trimers of isocyanate. Preferably, the isocyanate compound is selected from diisocyanate compounds such as for example methylene diphenyl isocyanate (MDI), polymethylene diphenyl isocyanate (PolyMDI), toluene diisocyanate (TDI); aliphatic isocyanates such as for example hexamethylene diisocyanate (HDI) or isophorone diisocyanate (IPDI); or mixtures thereof.

Also preferably, the polyol is a polyether polyol with a functionality from 2 to 4, for example a polyether polyol consisting of ethylene oxide, propylene oxide units or mixtures thereof. Also preferably, the polyol has a molecular mass comprised between 400 and 7,000 g/mol.

The composition (C1) may further include at least one polyester polyol; a chain extender such as for example ethylene glycol; a cross-linking molecule having a functionality of more than 2 such as for example glycerol; a catalyst such as for example a tertiary amine optionally substituted with a hydroxyl group such as dimethylaminopropylamine; an organometal salt such as for example dibutyl tin dilaurate; an emulsifier, a mineral filler; or fibers.

The blowing agent may have a chemical action or a physical action. Preferably, the blowing agent having a chemical action is water. Also preferably, the blowing agent having a physical action is an acyclic or cyclic aliphatic hydrocarbon C₄-C₈ compound, more preferentially C₄-C₆ compound. The acyclic or cyclic aliphatic hydrocarbon compound may be substituted with at least one halogen and may independently comprise at least one ether function, a ketone function or an acetate function.

According to the invention, the PVC resin is a suspended PVC resin, a bulk PVC resin, an emulsion PVC resin, a microsuspension PVC resin. An example of a suspension PVC resin is Lacovyl®S7015 with a Kwert of 70 marketed by Kem One. An example of a bulk PVC resin is Lacovyl®GB1040 with a Kwert of 65 marketed by Kem One. An example of an emulsion PVC resin is Lacovyl®PB1146 marketed by Kem One. According to the invention, the PVC resin is obtained by a suspension polymerization method, by a bulk polymerization method, by an emulsion polymerization method or by a microsuspension polymerization method.

Preferably, the PVC resin is selected from PVC resins for which the Kwert is comprised between 50 and 100, preferably between 60 and 85.

The Kwert value is measured according to a known method. The viscosity index evaluated according to the ISO R 174 standard is measured at 25° C. at a concentration of 0.5 g of PVC resin in 100 mL of cyclohexanone. To the obtained viscosity index corresponds a Kwert value given according to the DIN 53726 standard.

An example of the commercial product of the polyvinyl chloride with a Kwert of 70 is for example Lacovyl®S7015 marketed by Kem One. Also preferably, the suspension PVC resin is in the form of particles having an average size ranging from 30 to 500 μm, preferentially from 50 to 300 μm.

The average size of the particles is measured by laser granulometry.

According to the invention, the coating comprises a PVC resin or a mixture of PVC resins and a plasticizing compound (P2) in a mass ratio [PVC resin(s):(P2)] ranging from 100:50 to 100:150, preferably ranging from 100:65 to 100:135.

According to the invention, the coating may further comprise an epoxidized soybean oil or an epoxidized flaxseed oil, preferably an epoxidized soybean oil. An example of a commercial product of epoxidized soybean oil is Lankroflex® marketed by Akros Chemicals. Preferably, the coating comprises an epoxidized soybean oil and an epoxidized flax seed oil in a mass ratio [PVC resin(s): epoxidized soybean oil or flax seed oil] ranging from 100:25, preferably ranging up to 100:10.

According to the invention, the coating further comprises at least one thermal stabilizing agent, a pigment, a mold-removing agent and optionally a blowing agent or a UV stabilizer.

Preferably, the thermal stabilizing agent is selected from organometal salts including a metal such as zinc, calcium, barium, magnesium, potassium, lithium or tin; calcium hydroxide; calcium oxide; betadiketones; phenolic antioxidants; hydrotalcites; zeolites; perchlorate salts; phosphites; compounds comprising epoxide functions; or mixtures thereof.

An example of an organometal salt is zinc stearate.

Also preferably, the UV stabilizer is selected from UV-absorbant compounds, photostabilizers having at least one amine function sterically hindered and mixtures thereof.

According to the invention, the coating further comprises a thermal stabilizing agent and optionally a UV stabilizer in a mass ratio [PVC resin(s): thermal stabilizing agent and optionally UV stabilizer] ranging from 100:1 to 100:10, preferably ranging from 100:3 to 100:7.

According to the invention, the coating further comprises a mold-removal agent and a mass ratio [PVC resin(s): mold removal agent] of less than 100:3.

According to the invention, the coating further comprises a pigment in a mass ratio [PVC resin(s): pigment] ranging up to 100:20, preferably ranging from 100:0.3 to 100:7. Preferably, the pigment is in the form of a powder or a slurry.

Advantageously, the coating has a thickness comprised between 0.5 and 2.5 mm, preferably between 0.8 and 1.4 mm.

The invention relates to a method for preparing a composite according to the invention comprising:
a) preparation of a composition (C1) comprising at least one isocyanate compound comprising at least two isocyanate functions, at least one polyol compound comprising at least two alcohol functions, and at least one plasticizing compound (P1) according to the invention;
b) preparation of a composition (C2) comprising at least one PVC resin and at least one plasticizing compound (P2) according to the invention;
c) preparation of a coating by depositing the composition (C2) on the internal surface of a mold,
d) deposition in a mold for foaming the composition (C1) on the coating,
e) obtaining a polyurethane foam from the composition (C1) and removal from the mold of the composite according to the invention.

The composition (C2) preferably appears as a powder. Preferably, the composition (C2) may be deposited in a mold according to common molding techniques known to one skilled in the art, notably by spraying, rotomolding or by [symbol] slush-molding [symbol] . The deposition of the composition (C2) on the mold based on the electrostatic effect is known under the name of spraying.

By [symbol] deposition carried out by rotomolding [symbol] is meant a method giving the possibility of depositing a strictly necessary amount of composition (C2) introduced into the mold and by movements of rotation, the composition (C2) is deposited on the internal surface of the mold. For rotomolding the composition (C2) may be a plastisol, PVC resin dispersion, emulsion or micro suspension in some plasticizer.

By [symbol] deposition carried out by slush-molding [symbol] is meant a method giving the possibility of depositing a significant amount of composition (C2) relatively to the required amount. The unnecessary amount is then removed by gravity. In <<slush-molding>>, the whole of the device which comprises the mold (heated beforehand so as to have a surface temperature comprised between 180 and 250° C. as well as the reservoir comprising the composition (C2) which is coupled with the mold, is rotating when the composition (C2) is deposited. The contact time is generally comprised between 10 and 60 s. The number of rotations of the device is selected according to the thickness of the desired coating layer. The mold is then separated from the reservoir containing (C2). After an optional second passage in a so called post-gelling oven, the mold is cooled and the coating is removed from the mold.

The coating may be prepared by a combination of techniques, for example, a plastisol may be applied in a small thickness with a spray gun on all or part of the mold before heating the latter. Next, a slush molding sequence allows deposition of a layer of a composition (C2) of another color. This method gives the possibility of obtaining two-tone skins.

The isocyanate, polyol and plasticizer (P1) compounds comprised in the composition (C1) are intimately mixed just before deposition or injection onto the coating obtained from the composition (C2).

Alternatively, the plasticizing compound (P1) may be mixed beforehand with said at least one polyol compound, and then the obtained mixture is added at the last moment with the isocyanate.

Alternatively, the plasticizing compound (P1) may be distributed and mixed with said at least one isocyanate compound on the one hand and mixed on the other hand with said at least polyol compound, and then both mixtures are added at the last moment.

The polyurethane foam generally ensures the binding with a part in injected plastic which will be used as a support (for example a pieced injected with polypropylene). The foaming may be carried out in an open mold: the composition (C1) is poured onto the coating positioned in the foaming mold, and then the mold is closed until total expansion of the foam. The reactive mixture may alternatively be injected into the closed mold.

The invention relates to a composite which may be obtained with the method according to the invention.

The invention also relates to a composite according to the invention which may be obtained with the method according to the invention.

The invention relates to the use of the composite according to the invention for preparing a panel for automobile compartment portions selected from among a dashboard with an integrated or non-integrated airbag, an airbag hatch, a glove box, a central console, trim or a door panel.

The invention also relates to the use of a plasticizing compound (P1) selected from among the compounds and their derivatives stemming from the condensation between at least one acid comprising a linear, branched or cyclic, saturated or unsaturated, C₄-C₂₁ alkyl chain and comprising at least one acid function selected from among a carboxylic acid function, a sulfonic acid function or a phosphoric acid function, and at least one compound comprising at least one hydroxyl function within a foam of at least one polyurethane compound in contact with a coating comprising at least one PVC resin and at least one plasticizing compound (P2) selected from the compounds and their derivatives stemming from the condensation between at least one acid comprising a linear, branched or cyclic, saturated or unsaturated, C₄-C₂₁ alkyl chain and comprising at least one acid function selected from among a carboxylic acid function, a sulfonic acid function or a phosphoric acid function, and at least one compound comprising at least one hydroxyl function, for limiting or preventing migration of a plasticizing compound (P2) in the foam.

The invention also relates to the use of a plasticizing compound (P1) selected from among trimellitate compounds, sebacate compounds, adipate compounds and mixtures thereof within a foam of at least one polyurethane compound in contact with a coating comprising at least one PVC resin and at least one plasticizing compound (P2) selected from among trimellitate compounds, sebacate compounds, adipate compounds and mixtures thereof, in order to limit or prevent migration of a plasticizing compound (P2) into the foam.

The various aspects of the invention are illustrated by the following examples.

These examples are not a limitation of the scope of the invention.

### EXAMPLE 1

### Composites (1), (2) and Comparative Composite (3)

### 1.1. Foam Compositions (C1-1) to (C1-3)

Formulation of the foam compositions (C1-1), (C1-2) and (C1-3)

| | Proportion in percentage by mass | | |
|---|---|---|---|
| | Composition | Composition | Composition |
| | (C1-1) | (C1-2) | (C1-3) |
| Isocyanate⁽¹⁾ | 26.4 | 24.9 | 29.9 |
| Polyol⁽¹⁾ | 61.9 | 58.4 | 70.1 |
| Tris-(n-octyl)trimellitate⁽²⁾ | 11.70 | 16.70 | 0 |

⁽¹⁾Commercial formulation from Bayer Material Science comprising an isocyanate marketed under the brand Desmodur ® 58IF07M and a polyol marketed under the brand of Bayfill ®53IF40U.
⁽²⁾Tris-(n-octyl)trimellitate is marketed by Polynt under the brand Diplast ® TM8.

Preparation of the foam compositions (C1-1), (C1-2) and (C1-3).

Tris-(n-octyl)trimellitate, the polyol and the isocyanate were mixed in a reactor with stirring of 1,000 rpm for 10 seconds in order to obtain the composition (C1-1). The compositions (C1-2) and (C1-3) are prepared similarly to composition (C1-1).

### 1.2. PVC Composition (C2-1)

Formulation of the PVC composition (C2-1)

| Composition C2-1 | Proportion by mass |
|---|---|
| PVC suspension (Kwert of 70) | 100 |
| Tris-(n-octyl)trimellitate⁽²⁾ | 100 |
| Epoxidized soybean oil | 3 |
| Thermal and UV stabilizers | 5 |
| Pigments | 1 |
| PVC as an emulsion | 10 |
| Plasticizer level | 45% |

⁽²⁾Tris-(n-octyl)trimellitate is marketed by Polynt under the brand Diplast ® TM8.

Preparation of the PVC composition (C2-1) as a powder.

In a fast jacketed mixer are mixed together the PVC suspension (Kwert of 70), the thermal and UV stabilizer, the epoxidized soybean oil and the pigments. The temperature of the jacket is of about 140° C. When the mixture (PVC suspension (Kwert of 70)—UV and thermal stabilizer—pigments—epoxidized soybean oil) attained a temperature comprised between 80 and 120° C., the tris-(n-octyl)trimellitate heated beforehand to a temperature comprised between 80 and 100° C., was slowly added to the mixture. The thereby obtained mixture is mixed until total absorption of the plasticizer by the PVC suspension (Kwert of 70) and then, transferred in a cold mixture. To the mixture cooled to 50° C. is added a PVC emulsion resin in order to obtain the composition (C2-1) as a powder

1.3. Preparation of the Composite (1) from the Compositions (C1-1) and (C2-1)

250 g of the composition (C2-1) as a powder is poured on a nickel mold heated beforehand to 230° C. After 20 seconds, the mold is turned upside down in order to remove the excess powder, and then put back into the oven for 30 seconds in order to ensure proper gelling. After cooling, the skin is removed from the mold. The obtained skin has a thickness of about 1.2 mm. The composition (C1-1) is poured after 10 s of mixing, into a foaming mold with a height of 10 mm, on the coating positioned beforehand at the bottom of the mold. The thereby obtained assembly (mold-coating-composition (C1-1)) is placed in a press for 5 minutes until complete expansion of the foam obtained from the composition (C1-1), and then the assembly (coating-foam) is removed from the mold in order to obtain the composite (1).

1.4. Preparation of the Composite (2) from the Compositions (C1-2) and (C2-1)

The composite (2) is obtained in a similar way to the method for preparing the composite (1) from the composition (C1-2) foam and from the PVC formulation (C2-1).

1.5. Preparation of the Comparative Composite (3) from the Compositions (C1-3) and (C2-1)

The comparative composite (3) is obtained in a similar way to the method for preparing the composite (1) from the foam of composition (C1-3) and from the PVC formulation (C2-1). The density of the foam obtained for the composites (1) to (3) is comprised between 150 and 190 g/liter.

### EXAMPLE 2

### Measurements of the Mechanical Properties of the Coating of the Composites (1), (2) and (3) After Ageing

The composites (1), (2) and (3) were placed in a hot air oven at a temperature of 120° C. for 500 hours.

The coatings of the composites (1), (2) and (3) having been subject to ageing were separated from the foams, the excess foam is removed with a metal tool, before being cut by die-stamping in order to measure their mechanical properties after ageing.

Reference 1 corresponds to the non-aged coating which is the reference coating prepared from the composition (C2-1) and which has not been put into contact with a polyurethane foam.

The mechanical properties are measured according to the ISO527-3 standard at 23° C. and 100 mm/minute.

The measured mechanical properties are the strength at breakage (TS for Tensile Strength) measured in MPa, the elongation at break (TE for Tensile Elongation) measured as a percentage as well as the stress at 50% of elongation (TS50%) measured in MPa. The values of these mechanical properties as well as the variations of these mechanical properties relatively to the non-aged coating (reference 1) are given in table 1. The plasticizer weight content relatively to the weight of the PVC in the PVC coating determined by dosage by extraction is also given in Table 1.

TABLE 1
Mechanical properties and plasticizer level of the coatings of the
composites (1), (2) and (3) having undergone ageing relatively
to the reference 1.

| | | Aged | Aged | |
|---|---|---|---|---|
| | | coating of | coating of | |
| | | the | the | Aged coating of |
| Mechanical | | composite | composite | the composite |
| properties | Reference 1 | (1) | (2) | (3) |
| TS in MPa | 9.2 | 10.2 | 9.4 | 13.1 |
| TE in % | 328 | 284 | 274 | 218 |
| TS at 50% in | 2.9 | 3.4 | 3.0 | 6.9 |
| MPa | | | | |
| Plasticizer level | 45 | 43 | 44 | 34 |
| by weight | | | | |
| based on the | | | | |
| total weight of | | | | |
| the PVC in the | | | | |
| coating (%) | | | | |

It is seen that for the coatings of composites (1) and (2) according to the invention, the variation of the mechanical properties is much less than for the coating of the composition (3) without any plasticizer in the foam. These results are explained by a lesser migration of the plasticizer tris-(n-octyl)trimellitate, comprised in the coating towards the foam of PU for the coatings of the composites (1) and (2), because of the presence of the plasticizer in the foam.

### EXAMPLE 3

### Comparative Composite (4) and Composites (5) to (11)

### 3.1. Foam Compositions (C1-4) to (C1-11)

Formulation of the foam compositions (C1-4) to (C1-11)

| Composition | | | | | | | | |
|---|---|---|---|---|---|---|---|---|
| (proportion by mass) | (C1-4) | (C1-5) | (C1-6) | (C1-7) | (C1-8) | (C1-9) | (C1-10) | (C1-11) |
| Polyol⁽¹⁾ | 100 | 100 | 100 | 100 | 100 | 100 | 100 | 100 |
| Isocyanate⁽¹⁾ | 62 | 62 | 62 | 62 | 62 | 62 | 62 | 62 |
| Tris-(n-octyl, n-decanyl) | 0 | 5 | 10 | 22 | 36 | 51 | 70 | 108 |
| trimellitate⁽²⁾ | | | | | | | | |
| Plasticizer level by | 0 | 3 | 6 | 12 | 18 | 24 | 30 | 40 |
| weight in the foam | | | | | | | | |
| based on the total weight | | | | | | | | |
| of the foam (%) | | | | | | | | |

⁽¹⁾Commercial formulation from BASF marketed under the brand BASF Elastoflex ® comprising a polyol marketed as reference E3595/100 and an isocyanate marketed under the reference Iso 133/6.
⁽²⁾Tris-(n-octyl, n-decanyl)trimellitate is marketed by Polynt under the brand Diplast ® TM8-10/ST.

Preparation of the foam compositions (C1-4) to (C1-11).

The compositions (C1-4) to (C1-11) are obtained similarly to the method for preparing the composition (C1-1) described in Example 1. Tests were also conducted with 48% by weight of the plasticizer in the foam based on the total weight of the foam but the foam does not expand.

### 3.2. PVC Composition (C2-2)

Formulation of the PVC composition (C2-2)

| Composition | Proportion by mass |
|---|---|
| PVC suspension (Kwert 70) | 100 |
| tris-(n-octyl, n-decanyl) | 105 |
| trimellitate⁽²⁾ | |
| epoxidized soybean oil | 3 |
| Thermal and UV stabilizers | 5 |
| Pigments | 1 |
| PVC emulsion | 13 |
| Plasticizer level | 46% |

⁽²⁾Tris-(n-octyl, n-decanyl)trimellitate is marketed by Polynt under the brand Diplast ® TM8- 10/ST.

Preparation of the PVC composition (C2-2) as a powder.

The composition (C2-2) is obtained similarly to the method for preparing the composition (C2-1) described in Example 1.

### 3.3. Preparation of the Composites (4) to (11) From the Compositions (C1-4) to (C1-11) and (C2-2) Respectively

The composites (4) to (11) are obtained similarly to the method for preparing the composite (1) described in Example 1 from the compositions (C1-4) to (C1-11) and from the (C2-2) formulation.

The skins of the composites (4) to (11) obtained have a thickness of about 1.2 mm. The density of the foam obtained for the composites (4) to (11) is comprised between 150 and 300 g/liter.

### EXAMPLE 4

### Measurements of the Mechanical Properties of the Coating of the Composites (4) to (11) Overtime

The composites (4) to (11) were placed in a hot air oven at a temperature of 120° C. for 480 hours.

The coatings (4) to (11) of the composites (4) to (11) having undergone ageing were separated from the foams, the excess foam is removed with a metal tool, before cutting by die-stamping in order to measure their mechanical properties overtime.

Reference 2 in Table 2 below, corresponds to the non-aged coating which is the reference coating prepared from the composition (C2-2) and which was not put into contact with a polyurethane foam.

Reference 3 in Table 2 below corresponds to the non-aged coating which is the reference coating prepared from the composition (C2-2) and which was foamed with the foam prepared from the composition (C1-4), and then separated from the foam after 24 h of storage at ambient temperature and pressure.

The mechanical properties are measured according to the ISO527-3 standard at 23° C. and at 100 mm/minute. The measured mechanical properties are the stress at breakage (TS for Tensile Strength) measured in MPa, the elongation at break (TE for Tensile Elongation) measured as a percentage as well as the stress with 50% elongation (TS50%) measured in MPa. The values of these mechanical properties as well as the variations of these mechanical properties relatively to the non-aged coating are given in table 2. The plasticizer level by weight based on the weight of the PVC in the PVC coating determined by dosage by extraction is also given in this table.

TABLE 2
Mechanical properties and plasticizer level of the coatings (4) to (11) having undergone
ageing relatively to the references 2 and 3.

| | Reference | Reference | | | | | | | | |
|---|---|---|---|---|---|---|---|---|---|---|
| Coating | 2 | 3 | 4 | 5 | 6 | 7 | 8 | 9 | 10 | 11 |
| TS in MPa | 9.9 | 9.4 | 14.1 | 12.5 | 12.0 | 11.6 | 11.0 | 9.9 | 8.4 | 8.4 |
| TE in % | 427 | 375 | 288 | 325 | 350 | 365 | 388 | 370 | 344 | 342 |
| TS50% in MPa | 2.3 | 2.7 | 5.7 | 4.5 | 4.0 | 3.5 | 2.8 | 2.6 | 2.3 | 2.3 |
| Plasticizer level by | 46 | 45 | 37 | 40 | 42 | 43 | 45 | 45 | 46 | 46 |
| weight based on | | | | | | | | | | |
| the total weight of | | | | | | | | | | |
| the PVC in the | | | | | | | | | | |
| coating (%) | | | | | | | | | | |

The variation of the mechanical properties with respect to the non-aged coating is reduced for the coatings of the composites (5) to (11) according to the invention, unlike the coating of the composite (4). The plasticizer level is significantly higher for the coatings of composites (5) to (11) according to the invention, unlike the coating of the composite (4). A reduction in the migration of the plasticizer from the coating to the foam is therefore observed when the foam initially comprises a plasticizer.

### EXAMPLE 5

### Measurements of the Initial Reaction Times and Final Reaction Times and Measurements of the Densities of the Foams of the Compositions (C1-4) to (C1-11)

In order to evaluate the influence of the presence of tris-(n-octyl, n-decanyl)trimellitate on the reactivity of the polyurethane foam of compositions (C1-4) to (C1-11), the foams were freely expansed in containers of 3 liters.

The polyol and the tris-(n-octyl, n-decanyl)trimellitate were pre-mixed for about 20 s, and then the isocyanate composition was added, and the mixture mixed at 1,000 rpm for 10 s. The initial reaction and final reaction times were measured in an atmosphere at 23° C. and 50% of humidity, by taking as starting point the instant when the isocyanate composition was added. The density of the freely expansed foams was also measured. The mechanical properties were measured in compression at 100 mm/mins on the freely expansed foams. The corresponding compressive stress at 50% of compression is given in the table below. These measurements are indicated in table 3.

TABLE 3
Measurements of the initial reaction and final reaction times and measurements of the densities
and of the stress at 50% compression of the foams of compositions (C1-4) to (C1-11)

| Composition | | | | | | | | |
|---|---|---|---|---|---|---|---|---|
| of the foam | (C1-4) | (C1-5) | (C1-6) | (C1-7) | (C1-8) | (C1-9) | (C1-10) | (C1-11) |
| Plasticizer level | 0 | 3 | 6 | 12 | 18 | 24 | 30 | 40 |
| by weight in the | | | | | | | | |
| foam based on | | | | | | | | |
| the total weight | | | | | | | | |
| of the foam (%) | | | | | | | | |
| Initial reaction | 11.3 | 11.5 | 13 | 14.5 | 19 | 19.5 | 24 | 30 |
| time in seconds | | | | | | | | |
| Final reaction | 79 | 85 | 88 | 90 | 101 | 104 | 107 | 120 |
| time in seconds | | | | | | | | |
| Density in g/L | 49 | 50 | 55 | 58 | 63 | 69 | 78 | 88 |
| Stress at 50% | 18 | 15 | 14 | 13 | 11 | 10 | 9 | 7 |
| compression (kPa) | | | | | | | | |

It is observed that the addition of plasticizer within the compositions (C1-5) to (C1-10) slows down the reaction rate between the polyol and the isocyanate according to the added amount of plasticizer. It is also observed that this slowing down of the reaction rate between the polyol and the isocyanate is more significant for the composition (C1-11) comprising a 40% plasticizer level than for the compositions (C1-5) to (C1-10) for which the plasticizer level is comprised between 3 and 30%. Further, it is observed that for the composition (C1-11), the freely expansed foaming is extremely slowed down relatively to the compositions (C1-5) to (C1-10). It is also observed that the density of the foams of composition (C1-5) to (C1-11 comprising a plasticizer increases relatively to the density of the foam of composition (C1-4). More particularly, it is observed that the density of the foams of compositions (C1-5) to (C1-11) increases when the plasticizer level in the foam increases.

Moreover, the foams of compositions (C1-5) to (C1-11) are stretched relatively to the foam of composition (C1-4). However, the foam obtained from the composition (C1-11) has degraded mechanical properties as compared with the foams obtained from the compositions (C1-5) to (C1-10), which are expressed by a density of the foam greater than 80 g/L, more particularly 88 g/L and a stress at 50% compression of 7 kPa.

### EXAMPLE 6

### Composites (12) to (15)

### 6.1 Foam Composition (C1-12) to (C1-15)

Formulation of the foam compositions (C1-12) to (C1-15)

| Foam composition (proportion by mass) | | | |
|---|---|---|---|
| (C1-12) | (C1-13) | (C1-14) | (C1-15) |

Formulation of the polyol composition

| | | | | |
|---|---|---|---|---|
| Polyol A⁽³⁾ | 79.98 | 79.98 | 79.98 | 79.98 |
| Polyol B⁽⁴⁾ | 14.29 | 14.29 | 14.29 | 14.29 |
| Butane-1,4-diol⁽⁵⁾ | 2 | 2 | 2 | 2 |
| Triethanolamine⁽⁵⁾ | 0.15 | 0.15 | 0.15 | 0.15 |
| Purified water | 3 | 3 | 3 | 3 |
| DBTDL⁽⁵⁾ | 0.02 | 0.02 | 0.02 | 0.02 |
| Potassium acetate 25% | 0.5 | 0.5 | 0.5 | 0.5 |
| EC⁽⁵⁾ | | | | |

Formulation of the isocyanate composition

| | | | | |
|---|---|---|---|---|
| PM-200⁽⁶⁾ | 41.93 | 41.93 | 41.93 | 41.93 |
| tris-(n-octyl, n-decanyl) | 0 | 8.54 | 17.08 | 25.63 |
| trimellitate⁽²⁾ | | | | |
| plasticizer level in the | 0 | 6 | 12 | 18 |
| composition of the foam | | | | |
| (%) | | | | |

⁽²⁾The tris-(n-octyl, n-decanyl)trimellitate is marketed by Polynt under the brand Diplast ®TM8-10/ST.
⁽³⁾A polyether polyol having a number of —OH functions comprised between 33.5 and 36.5 mg KOH/g marketed under the brand CHE-360N ®, by JCPST (Jiangsu Changhua Polyurethane Science & Technology Co., Ltd.).
⁽⁴⁾A polyol having a number of —OH functions comprised between 19 and 23 mg of KOH/g marketed under the brand CHP-H45 ®, by JCPST.
⁽⁵⁾Butane-1,4-diol, triethanolamine, DBTDL (Di-N-butyldilauryltin-CAS number 77-58-7), and potassium acetate 25% EC are marketed by Sinopharm chemical reagent Co. Ltd.
⁽⁶⁾A polymer of methylene diphenyl isocyanate having an isocyanate functionality level comprised between 2.6 and 2.7 marketed under the brand PM-200 ®, by Yantai Wanhua Polyurethanes Co., Ltd.

Preparation of the foam compositions (C1-12) to (C1-15)

The products of the polyol composition are premixed beforehand by means of a laboratory mixer rotating at 2,000 revolutions per minute for 5 minutes. The plasticizer is then added to the polyol composition obtained previously, and then the polyol composition comprising the plasticizer is mixed for 20 s. The isocyanate composition is then added to the polyol composition comprising a plasticizer obtained previously and then the whole is mixed for about ten seconds.

### 6.2 PVC Composition (C2-3)

Formulation of the PVC composition (C2-3)

| Composition | Proportion by mass |
|---|---|
| PVC suspension (Kwert 70) | 100 |
| tris-(n-octyl, n-decanyl) | 100 |
| trimellitate⁽²⁾ | |
| epoxidized soybean oil | 3 |
| Thermal and UV stabilizers | 5 |
| Pigments | 1 |
| PVC emulsion | 11 |
| Plasticizer level | 44% |

⁽²⁾Tris-(n-octyl, n-decanyl)trimellitate is marketed by Polynt under the brand Diplast ® TM8- 10/ST.

Preparation of the PVC composition (C2-3) as a powder.

The composition (C2-3) is obtained similarly to the method for preparing the composition (C2-1) described in Example 1.

### 6.3 Preparation of the Composites (12) to (15) From the Compositions (C1-12) to (C1-15)

The composites (12) to (15) are obtained similarly to the method for preparing the composite (1) described in Example 1 from foams of compositions (C1-12) to (C1-15) and from the PVC formulation (C2-3).

The skins of the composites (12) to (15) obtained have a thickness of about 1.2 mm.

The density of the foam obtained for the composites (12) to (15) is comprised between 140 and 200 g/liter.

### EXAMPLE 7

### Measurements of the Mechanical Properties of the Coating of the Composites (12) to (15)

The composites (12) to (15) were placed in a hot air oven at a temperature of 120° C. for 500 hours.

The coatings (12) to (15) of the composites (12) to (15) having undergone ageing were separated from the foams, the excess foam was removed with a metal tool, before cutting by die-stamping in order to measure their mechanical properties overtime.

Reference 4 in table 4 below corresponds to the non-aged coating which is the reference coating prepared from the composition (C2-3), which was put into contact with the foam obtained from the composition (C1-12) and then separated from the foam after 24 h of storage at ambient temperature and pressure.

The plasticizer content by weight based on the weight of the PVC in the PVC coating determined by dosage by extraction is also given in this table.

TABLE 4
Mechanical properties and plasticizer level of the coatings (12) to (15)
having undergone ageing as compared with reference 4.

| Coating | Reference 4 | 12 | 13 | 14 | 15 |
|---|---|---|---|---|---|
| TS in MPa | 9.1 | 13.1 | 12.4 | 12.4 | 10.8 |
| TE in % | 306 | 256 | 269 | 295 | 296 |
| TS50% in | 3.3 | 6.1 | 5.3 | 4.8 | 3.6 |
| MPa | | | | | |
| Plasticizer | 44 | 36 | 38 | 39 | 43 |
| level by | | | | | |
| weight | | | | | |
| based on | | | | | |
| the total | | | | | |
| weight of | | | | | |
| the PVC in | | | | | |
| the coating | | | | | |
| (%) | | | | | |

The variation of the mechanical properties relatively to the non-aged coating is reduced for the coatings of the composites (13) to (15) according to the invention, unlike the coating of the composite (12). The plasticizer level is significantly higher for the coatings of the composites (13) to (15) according to the invention, unlike the coating of the composite (12). A reduction in the migration of the plasticizer from the coating to the foam is therefore observed when the foam initially comprises a plasticizer.

### EXAMPLE 8

### Measurements of the Initial Reaction and Final Reaction Times and Measurements of the Densities of the Foams of Compositions (C1-12) to (C1-15)

In order to evaluate the influence of the presence of tris-(n-octyl, n-decanyl)trimellitate on the reactivity of the polyurethane foam of compositions (C1-12) to (C1-15), the foams were freely expansed in 3 liter containers.

The polyol composition and the tris-(n-octyl, n-decanyl)trimellitate were pre-mixed for about 20 s, and then the isocyanate composition was added, and the mixture mixed at 1,000 rpm for 10 s. The initial reaction and final reaction times were measured in an ambient atmosphere at 23° C. and with 50% humidity, by taking as starting point the instant when the isocyanate composition was added. The density of the freely expansed foams was also measured. These measurements are indicated in table 5.

TABLE 5
Measurements of the initial reaction and final reaction times and
measurements of the densities of the foams of compositions
(C1-12) to (C1-15)

| | Composition of the foam | | | |
|---|---|---|---|---|
| | (C1-12) | (C1-13) | (C1-14) | (C1-15) |
| Initial reaction time | 14 | 20 | 27 | 30 |
| in seconds | | | | |
| Final reaction time in | 104 | 108 | 111 | 128 |
| seconds | | | | |
| Density in g/l | 73 | 76 | 81 | 116 |
| Stress at 50% | 29 | 36 | 30 | 29 |
| compression (kPa) | | | | |

It is observed that the addition of a plasticizer within the compositions (C1-13) to (C1-15) slows down the reaction rate between the polyol and the isocyanate in proportion with the added amount of plasticizer.

It is also observed that the density of the foams of compositions (C1-13) to (C1-15) comprising a plasticizer increases as compared with the density of the foam of composition (C1-12). More particularly, it is observed that the density of the foams of compositions (C1-13) to (C1-15) increases when the plasticizer level in the foam increases.

### EXAMPLE 9

### Composites (16) to (19)

### 9.1 Foam Compositions (C1-16) to (C1-19)

Formulation of the foam compositions (C1-16) to (C1-19)

| | Composition (proportion by mass) | | | |
|---|---|---|---|---|
| | (C1-16) | (C1-17) | (C1-18) | (C1-19) |
| Polyol⁽¹⁾ | 100 | 100 | 100 | 100 |
| Isocyanate⁽¹⁾ | 62 | 62 | 62 | 62 |
| tris-(n-octyl) | 0 | 36 | 25 | 11 |
| trimellitate⁽²⁾ | | | | |
| di-(isodecyl) | 0 | 0 | 11 | 25 |
| sebacate⁽³⁾ | | | | |
| Plasticizer level by | 0 | 18 | 18 | 18 |
| weight in the foam | | | | |
| based on the total | | | | |
| weight of the foam (%) | | | | |

⁽¹⁾Commercial formulation from BASF marketed under the brand BASF Elastoflex ® comprising a polyol marketed under reference E3595/100 and an isocyanate marketed under reference Iso 133/6
⁽²⁾Tris-(n-octyl)trimellitate is marketed by Polynt under the brand Diplast ® TM8.
⁽³⁾Di-(isodecyl) sebacate is marketed by INEOS Enterprises under the brand CEREPLAS DIDS.

Preparation of the foam compositions (C1-16) to (C1-19)

The compositions (C1-16) to (C1-19) are obtained similarly to the method for preparing the composition (C1-1) described in Example 1.

### 9.2 PVC Composition (C2-4)

Formulation of the PVC composition (C2-4)

| | Proportion by |
|---|---|
| Composition | mass |
| PVC suspension (Kwert 70) | 100 |
| tris-(n-octyl) trimellitate⁽²⁾ | 58 |
| di-(isodecyl) sebacate⁽³⁾ | 27 |
| epoxidized soybean oil | 3 |
| Thermal and UV stabilizers | 5 |
| Pigments | 1 |
| PVC emulsion | 11 |
| Plasticizer level | 42% |

⁽²⁾Tris-(n-octyl)trimellitate is marketed by Polynt under the brand Diplast ® TM8.
⁽³⁾Di-(isodecyl) sebacate is marketed by INEOS Enterprises under the brand CEREPLAS DIDS.

Preparation of the PVC composition (C2-4) as a powder

The composition (C2-4) is obtained similarly to the method for preparing the composition (C2-1) described in Example 1.

### 9.3 Preparation of the Composites (16) to (19) From the Compositions (C1-16) to (C1-19)

The composites (16) to (19) are obtained similarly to the method for preparing the composite (1) described in Example 1 from the foams of compositions (C1-16) to (C1-19) and from the PVC formulation (C2-4).

The skins of the composites (16) to (19) obtained have a thickness of about 0.9 mm.

The density of the foam obtained for the composites (16) to (19) is comprised between 170 and 230 g/liter.

### EXAMPLE 10

### Measurements of the Mechanical Properties of the Coating of the Composites (16) to (19)

The composites (16) to (19) were placed in a hot air oven at a temperature of 120° C. for 500 hours.

The coatings (16) to (19) of the composites (16) to (19) having undergone ageing were separated from the foams, the excess foam is removed with a metal tool, before cutting by die-stamping in order to measure their mechanical properties overtime.

Reference 5 in the table 5 below, corresponds to the non-aged coating which is the reference coating prepared from the composition (C2-4), which was put into contact with the foam obtained from the composition (C1-16) and then separated from the foam after 24 h of storage at room temperature and ambient pressure.

The plasticizer content by weight based on the weight of the PVC in the PVC coating determined by dosage by extraction is also given in this table.

TABLE 5
Mechanical properties and plasticizer level of the coatings (16) to (19)
having undergone ageing relatively to the reference 5.

| Coating | Reference 5 | 16 | 17 | 18 | 19 |
|---|---|---|---|---|---|
| TS in MPa | 11.1 | 18.2 | 13.3 | 14.2 | 15.2 |
| TE in % | 306 | 250 | 250 | 280 | 280 |
| TS50% in | 4.0 | 9.2 | 5.0 | 5.3 | 6.3 |
| MPa | | | | | |
| Plasticizer | 42 | 29 | 39 | 38 | 36 |
| level by | | | | | |
| weight | | | | | |
| based on | | | | | |
| the total | | | | | |
| weight of | | | | | |
| the PVC in | | | | | |
| the coating | | | | | |
| (%) | | | | | |

The variation of the mechanical properties relatively to the non-aged coating is reduced for the coatings of the composites (17) to (19) according to the invention, unlike the coating of the composite (16). The plasticizer level is significantly higher for the coatings of the composites (17) to (19) according to the invention, unlike the coating of the composite (16). A reduction in the migration of the plasticizer from the coating to the foam is therefore observed when the foam initially comprises plasticizer.

Further, by performing an infrared analysis of the coatings (17) to (19), it is observed that the relative composition in tris-(n-octyl)trimellitate and di-(isodecyl)sebacate comprised in the coating (18) having undergone ageing is the closest to the relative composition in tris-(n-octyl)trimellitate and di-(isodecyl)sebacate comprised in the non-aged coating (reference 5). For the coating (17) having undergone ageing, it is observed by infrared analysis that the relative content of tris-(n-octyl)trimellitate comprised in the coating (17) is greater than that of the non-aged coating (reference 5). Conversely, the coating (19) having undergone ageing is relatively richer in di-(isodecyl)sebacate than the non-aged coating (reference 5).

1. A composite comprising:
a foam of at least one polyurethane compound comprising at least one plasticizing compound selected from among the compounds and their derivatives stemming from the condensation between at least one acid comprising a linear, branched or cyclic, saturated or unsaturated, C₄-C₂₁ alkyl chain and comprising at least one acid function selected from among a carboxylic acid function, a sulfonic acid function or a phosphoric acid function, and at least one compound comprising at least one hydroxyl function; and
a coating comprising at least one PVC resin and at least one plasticizing compound selected from among the compounds and their derivatives stemming from the condensation between at least one acid comprising a linear, branched or cyclic, saturated or unsaturated, C₄-C₂₁ alkyl chain and comprising at least one acid function selected from among a carboxylic acid function, a sulfonic acid function or a phosphoric acid function, and at least one compound comprising at least one hydroxyl function,
wherein the foam comprises from 3 to 30% by weight of a plasticizing compound based on the total weight of foam.

2. The composite according to claim 1, wherein during its making, the foam comprises from 3 to 30% by weight of a plasticizing compound based on the total weight of foam.

3. The composite according to claim 1, wherein it is non-aged.

4. The composite according to claim 1, wherein the foam comprises from 10 to 30% by weight of a plasticizing compound based on the total weight of foam.

5. The composite according to claim 1, wherein the plasticizing compound and the plasticizing compound are identical or are different.

6. The composite according to claim 1, wherein the plasticizing compound or is independently selected from among the esters obtained from a plant oil or from among the compounds and their derivatives, stemming from the condensation between:
at least one acid comprising a linear, branched or cyclic, saturated or unsaturated, C₄-C₂₁ alkyl chain and comprising at least two carboxylic acid functions, and at least one compound comprising a hydroxyl function;
at least one acid comprising a linear, branched or cyclic, saturated or unsaturated, C₄-C₂₁ alkyl chain and comprising a carboxylic acid function, and a compound comprising at least two hydroxyl functions;
at least one acid comprising a linear, branched or cyclic, saturated or unsaturated, C₄-C₂₁ alkyl chain and comprising two carboxylic acid functions, and at least one compound comprising two hydroxyl functions;
at least one acid comprising a linear, branched or cyclic, saturated or unsaturated, C₄-C₂₁ alkyl chain and comprising at least one sulfonic acid function, and at least one compound comprising a hydroxyl function;
at least one acid comprising a linear, branched or cyclic, saturated or unsaturated, C₄-C₂₁ alkyl chain and comprising at least one phosphoric acid function, and at least one compound comprising a hydroxyl function; or
mixtures thereof.

7. The composite according to claim 1, wherein the plasticizing compound or the plasticizing compound is independently selected from trimellitate compounds; sebacate compounds; adipate compounds; polyadipate compounds; phthalate compounds; polyphthalate compounds; terephthalate compounds; citrate compounds; polyglutarate compounds; maleate compounds; polyethyleneglycol polyether compounds; acetylated monoglyceride compounds; compounds stemming from the condensation between at least one acid comprising a linear or branched C₄-C₂₁ alkyl chain and comprising a carboxylic acid function, and at least one compound selected from among glycerol, diglycerol, neopentylglycol, trimethylolpropane, monopentaerythritol or dipentaerythritol; di-iso-nonyl 1,2-cyclohexane dicarboxylate; sulfonate compounds; phosphate compounds; or mixtures thereof.

8. The composite according to claim 1, wherein the coating comprises a PVC resin or a mixture of PVC resins and a plasticizing compound in a [PVC resin(s): plasticizing compound] mass ration ranging from 100:50 to 100:150, preferably ranging from 100:65 to 100:135.

9. The composite according to claim 1, wherein the coating further comprises an epoxidized soybean oil or a flax seed oil, preferably an epoxidized soybean oil.

10. A method for preparing a composite comprising a foam of at least one polyurethane compound comprising at least one plasticizing compound selected from among compounds and their derivatives stemming from the condensation between at least one acid comprising a linear, cyclic or branched, saturated or unsaturated, C₄-C₂₁, alkyl chain and comprising at least one acid function selected from among a carboxylic acid function, a sulfonic acid function, or a phosphoric acid function, and at least one compound comprising at least one hydroxyl function;
a coating comprising at least one PVC resin and at least one plasticizing compound selected from among compounds and their derivatives stemming from the condensation between at least one acid comprising a linear, cyclic or branched, saturated or unsaturated, C₄-C₂₁, alkyl chain and comprising at least one acid function selected from among a carboxylic acid function, a sulfonic acid function, or a phosphoric acid function, and at least one compound comprising at least one hydroxyl function, comprising:
a) the preparation of a composition comprising at least one isocyanate comprising at least two isocyanate functions, at least one polyol compound comprising at least two alcohol functions, at least one blowing agent and at least one plasticizing compound selected from among the compounds and their derivatives stemming from the condensation between at least one acid comprising a linear, branched or cyclic, saturated or unsaturated, C₄-C₂₁ alkyl chain and comprising at least one acid function selected from among a carboxylic acid function, a sulfonic acid function or a phosphoric acid function, and at least one compound comprising at least one hydroxyl function;
b) the preparation of a composition comprising at least one PVC resin and at least one plasticized compound selected from among the compounds and their derivatives stemming from the condensation between at least one acid comprising a linear, branched or cyclic, saturated or unsaturated, C₄-C₂₁ alkyl chain and comprising at least one acid function selected from among a carboxylic acid function, a sulfonic acid function or a phosphoric acid function, and at least one compound comprising at least one hydroxyl function;
c) the preparation of a coating by depositing the composition on the internal surface of a mold,
d) the deposition in a foaming mold of the composition on the coating, and
e) obtaining a polyurethane foam from the composition and from removing the composite from the mold.

11. A composite produced by the method according to claim 10.

12. The composite according to claim 11, comprises:
a foam of at least one polyurethane compound comprising at least one plasticizing compound selected from among the compounds and their derivatives stemming from the condensation between at least one acid comprising a linear, branched or cyclic, saturated or unsaturated, C₄-C₂₁ alkyl chain and comprising at least one acid function selected from among a carboxylic acid function, a sulfonic acid function or a phosphoric acid function, and at least one compound comprising at least one hydroxyl function; and
a coating comprising at least one PC resin and at least one plasticizing compound selected from among the compounds and their derivatives stemming from the condensation between at least one acid comprising a linear, branched or cyclic, saturated or unsaturated, C₄-C₂₁ alkyl chain and comprising at least one acid function selected from among a carboxylic acid function, a sulfonic acid function or a phosphoric acid function, and at least one compound comprising at least one hydroxyl function,
wherein the foam comprises from 3 to 30% by weight of a plasticizing compound based on the total weight of foam.

13. The use of a composite according to claim 1, for preparing a panel intended for automobile compartment portions selected from among a dashboard with integrated or non-integrated airbag, an airbag hatch, a glovebox, trim or door panel.

14. The use of a plasticizing compound selected from among compounds and their derivatives stemming from the condensation between at least one acid comprising a linear, cyclic or branched, saturated or unsaturated, C₄-C₂₁, alkyl chain and comprising at least one acid function selected from among a carboxylic acid function, a sulfonic acid function, or a phosphoric acid function, and at least one compound comprising at least one hydroxyl function, within a foam of at least one polyurethane compound in contact with a coating comprising at least one PVC resin and at least one plasticizing compound selected from among compounds and their derivatives stemming from the condensation between at least one acid comprising a linear, cyclic or branched, saturated or unsaturated, C₄-C₂₁, alkyl chain and comprising at least one acid function selected from among a carboxylic acid function, a sulfonic acid function, or a phosphoric acid function, and at least one compound comprising at least one hydroxyl function, for limiting or preventing migration of one plasticizing compound in the foam.
